(19) United States
(12) Patent Application Publication
(10) Pub. No.: US 2009/0234523 A1
(43) Pub. Date: Sep. 17, 2009

(54) SYSTEM AND METHOD FOR DETERMINING A QUALITY OF A LOCATION ESTIMATION OF A POWERED SYSTEM

(76) Inventors: Vishram Vinayak Nandedkar, Bangalore (IN); Ajith Kuttannair Kumar, Erie, PA (US)

Correspondence Address: BEUSSE WOLTER SANKS MORA & MAIRE, P.A., 390 NORTH ORANGE AVENUE, SUITE 2500, ORLANDO, FL, 32801, US

(21) Appl. No.: 12/047,496

(22) Filed: Mar. 13, 2008

(51) Int. Cl. G01S 5/00; G05D 13/62; G06F 17/17

(52) U.S. Cl. 701/20; 701/300; 701/19; 701/216; 701/207

(57) ABSTRACT

A system is provided for determining a quality of a location estimation of a powered system at a location. The system includes a first sensor configured to measure a first parameter of the powered system at the location. The system further includes a second sensor configured to measure a second parameter of the powered system at the location. The system further includes a second controller configured to determine the location estimation of the powered system and the quality of the location estimation, based upon a first location of the powered system based on the first parameter, and a second location of the powered system based on the second parameter of the powered system. A method is also provided for determining a quality of a location estimation of a powered system at a location.

### BACKGROUND OF THE INVENTION

Rail vehicles, such as a train having one or more locomotives, for example, travel along a route from one location to another. Some trains travel along the route in an automatic mode, in which, prior to traveling along the route, a controller predetermines one or more train parameters, such as speed and notch setting, for example, at each location along the route. In order to predetermine the train parameter(s) at each location along the route, the controller may use a memory which prestores a characteristic of the route at each location, such as the grade, for example. While traveling along the route, it is important for the controller to be aware of the train location, to ensure that the actual train parameter(s) track the predetermined train parameter(s), at each train location. Additionally, since the route may include various train parameter restrictions, such as a speed restriction, for example, the controller needs to be aware when the train location is approaching a train parameter restriction location, so to adjust the train parameter(s), if needed, to comply with the train parameter restriction.

Alternatively, the train may travel along the route in a manual mode, in which the train operator is responsible for manually adjusting the train parameter(s). As with the automatic mode, while traveling along the route, it is important for the train operator to be aware of the train location, such as when the train location approaches a train parameter restriction location, for example. The train operator would then manually adjust the train parameter(s) to comply with a train parameter restriction.

Conventional systems have been designed to assist the controllers in the automatic mode and the train operators in the manual mode, to provide a location of the train, as the train travels along the route. However, these conventional systems rely solely on a global positioning satellite (GPS) system, which provides one measurement of the train location, based on satellite positioning or other positioning systems using wireless network or wayside equipment, for example. Upon receiving the positioning system measurement, the controller typically uses its memory to convert this raw position measurement to a distance measurement along the route.

As with any measurement system, the position measurement system is capable of error, such as if the GPS receiver of the train fails to communicate with a sufficient number of satellites, or an error in the memory of the controller which may convert an accurate raw GPS measurement to an inaccurate distance measurement along the route, for example. Accordingly, it would be advantageous to provide an independent distance measurement in addition to the GPS measurement along the route, so to ensure that the distance estimation provided to the controller or train operator is somewhat reliable. Additionally, it would be advantageous to assign a quality value to the distance estimation provided to the controller or train operator.

### BRIEF DESCRIPTION OF THE INVENTION

In one embodiment of the present invention, a system is provided for determining a quality of a location estimation of a powered system at a location. The system includes a first sensor configured to measure a first parameter of the powered system at the location. The system further includes a second sensor configured to measure a second parameter of the powered system at the location. The system further includes a second controller configured to determine the location estimation of the powered system and the quality of the location estimation, based upon a first location of the powered system based on the first parameter, and a second location of the powered system based on the second parameter of the powered system.

In one embodiment of the present invention, a system is provided for determining a quality of a location estimation of a powered system at a location. The system includes a speed sensor configured to determine a speed of the powered system at the location. The system further includes a position determination device configured to provide a measured position of the powered system. The system further includes a second controller configured to determine the quality of the location estimation during a first time period when the position determination device provides the measured position of the powered system. The quality is based on at least one of an uncertainty in the position of the powered system and an uncertainty in the speed of the powered system.

In one embodiment of the present invention, a method is provided for determining a quality of a location estimation of a powered system at a location. The method includes measuring a speed of the powered system at the location, and measuring a position of the powered system. The method further includes determining the location estimation of the powered system and the quality of the location estimation. The step of determining the location estimation and quality of the location estimation is based upon a first location of the powered system based on the speed, and a second location of the powered system based on the measured position of the powered system.

### BRIEF DESCRIPTION OF THE DRAWINGS

A more particular description of the embodiments of the invention briefly described above will be rendered by reference to specific embodiments thereof that are illustrated in the appended drawings. Understanding that these drawings depict only typical embodiments of the invention and are not therefore to be considered to be limiting of its scope, the embodiments of the invention will be described and explained with additional specificity and detail through the use of the accompanying drawings in which:

FIG. 1 is a side plan view of an exemplary embodiment of a system for determining a quality of a distance estimation of a rail vehicle at a location along a route;

FIG. 2 is a side plan view of an exemplary embodiment of a system for determining a quality of a distance estimation of a rail vehicle at a plurality of locations along a route;

FIG. 3 is a plot of an exemplary embodiment a quality of a distance estimation of the rail vehicle at a plurality of locations along a route;

FIG. 4 is a plot of an exemplary embodiment a quality of a distance estimation of the rail vehicle at a plurality of locations along a route;

FIG. 5 is a plot of an exemplary embodiment a quality of a distance estimation of the rail vehicle at a plurality of locations along a route;

FIG. 6 is a block diagram of an exemplary embodiment of a second controller configured to determine a quality of a distance estimation of a rail vehicle at a plurality of locations along a route;

FIG. 7 is a side plan view of an exemplary embodiment of a system for determining a quality of a distance estimation of a rail vehicle at a location along a route; and

FIG. 8 is a flow chart illustrating an exemplary embodiment of a method for determining a quality of a distance estimation of a rail vehicle at a location along a route.

### DETAILED DESCRIPTION OF THE INVENTION

In describing particular features of different embodiments of the present invention, number references will be utilized in relation to the figures accompanying the specification. Similar or identical number references in different figures may be utilized to indicate similar or identical components among different embodiments of the present invention.

Though exemplary embodiments of the present invention are described with respect to rail vehicles, or railway transportation systems, specifically trains and locomotives having diesel engines, exemplary embodiments of the invention are also applicable for other uses, such as but not limited to off-highway vehicles, marine vessels, stationary units, and, agricultural vehicles, transport buses, each which may use at least one diesel engine, or diesel internal combustion engine. Towards this end, when discussing a specified mission, this includes a task or requirement to be performed by the diesel powered system. Therefore, with respect to railway, marine, transport vehicles, agricultural vehicles, or off-highway vehicle applications this may refer to the movement of the system from a present location to a destination. In the case of stationary applications, such as but not limited to a stationary power generating station or network of power generating stations, a specified mission may refer to an amount of wattage (e.g., MW/hr) or other parameter or requirement to be satisfied by the diesel powered system. Likewise, operating condition of the diesel-fueled power generating unit may include one or more of speed, load, fueling value, timing, etc. Furthermore, though diesel powered systems are disclosed, those skilled in the art will readily recognize that embodiment of the invention may also be utilized with non-diesel powered systems, such as but not limited to natural gas powered systems, bio-diesel powered systems, etc. Furthermore, as disclosed herein such non-diesel powered systems, as well as diesel powered systems, may include multiple engines, other power sources, and/or additional power sources, such as, but not limited to, battery sources, voltage sources (such as but not limited to capacitors), chemical sources, pressure based sources (such as but not limited to spring and/or hydraulic expansion), current sources (such as but not limited to inductors), inertial sources (such as but not limited to flywheel devices), gravitational-based power sources, and/or thermal-based power sources.

In one exemplary example involving marine vessels, a plurality of tugs may be operating together where all are moving the same larger vessel, where each tug is linked in time to accomplish the mission of moving the larger vessel. In another exemplary example a single marine vessel may have a plurality of engines. Off Highway Vehicle (OHV) may involve a fleet of vehicles that have a same mission to move earth, from location A to location B, where each OHV is linked in time to accomplish the mission. With respect to a stationary power generating station, a plurality of stations may be grouped together collectively generating power for a specific location and/or purpose. In another exemplary embodiment, a single station is provided, but with a plurality of generators making up the single station. In one exemplary example involving locomotive vehicles, a plurality of diesel powered systems may be operating together where all are moving the same larger load, where each system is linked in time to accomplish the mission of moving the larger load. In another exemplary embodiment a locomotive vehicle may have more than one diesel powered system.

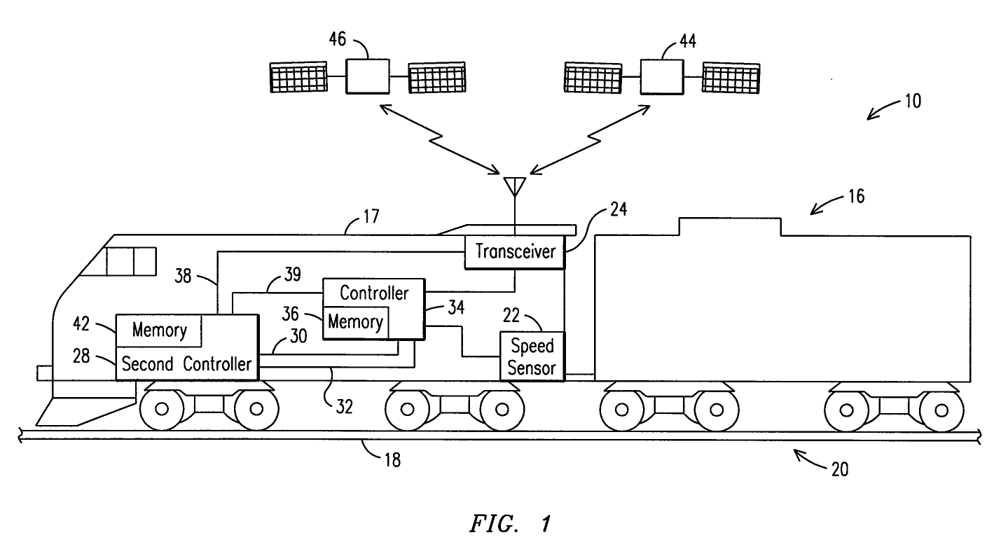

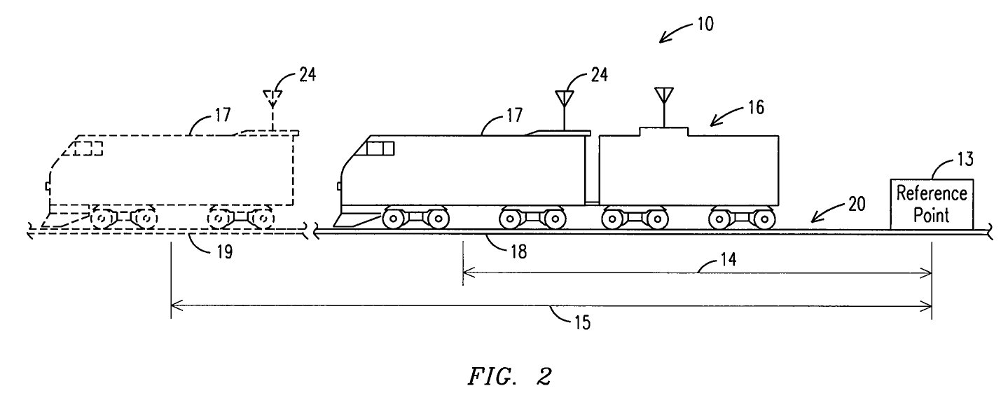

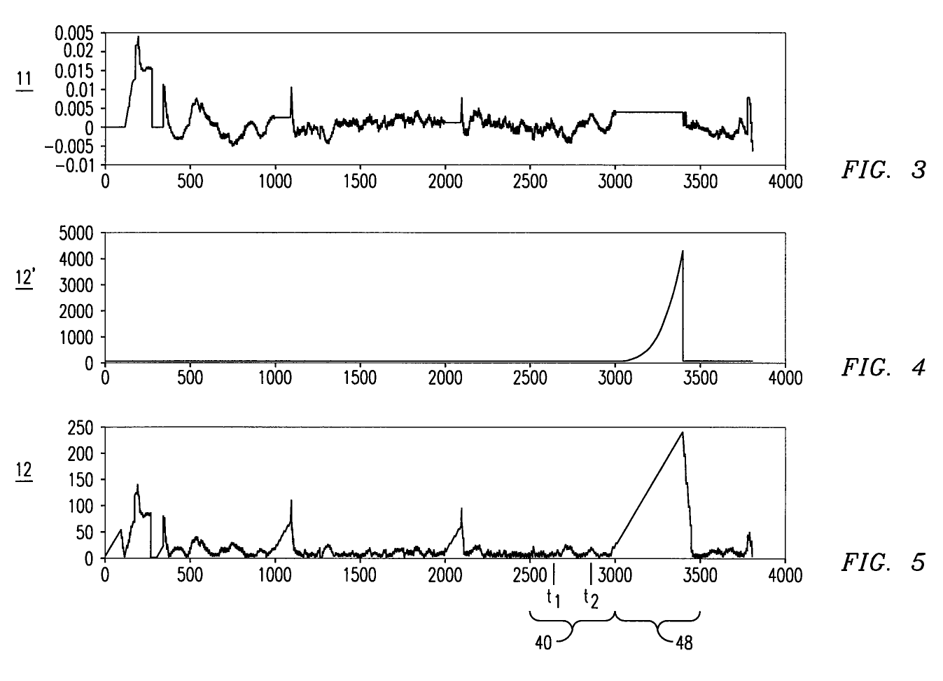

FIGS. 1-2 illustrates an exemplary embodiment of a system 10 for determining a quality 12 (FIGS. 3-4) of a distance estimation 14 of a rail vehicle, such as a train 16 including a locomotive 17, for example, at a location 18 along a route 20. The distance estimation 14 is based on a reference point 13 along the route 20, such as a destination location of a trip, a city boundary, a milestone, a wayside device, or any similar reference point. Although the reference point 13 in FIG. 1 is a previous location along the route 20, the reference point may be a future location along the route, for example. Although the illustrated embodiments of FIGS. 1-7 illustrate a system for determining a quality of a distance estimation of a rail vehicle, such as a train, along a route, the embodiments of the present invention may be employed for any powered system, such as off-highway vehicles (OHV), marine vehicles, in addition to other applications, for example, which do not travel along a rail. The embodiments of the present-invention may be employed to determine a location estimation and a respective quality of the location estimation for these powered systems, as the powered systems do not necessarily follow a prescribed distance along a predetermined route, as with a rail vehicle, for example.

The system 10 includes a speed sensor 22 positioned on the locomotive 17 to measure a speed of the train 16 at the location 18 along the route 20. The speed sensor may be any type of conventional speed sensor used to measure the speed of a locomotive, as appreciated by one of skill in the art. The system 10 further includes a controller 34 coupled to the speed sensor 22. The controller 34 determines a first distance 30 of the train 16 from the reference point 13 along the route 20 based on the speed of the train 16 from the reference point 13 to the location 18 along the route 20. As will be appreciated by one of skill in the art, the controller 34 integrates the speed of the train 16 over the time period that the train 16 travels between the reference point 13 and the location 18, to determine the first distance 30. Although the speed sensor 22 illustrated in FIG. 1 is configured to send speed data to the controller 34, and the controller 34 calculates the first distance 30, speed sensors may be utilized in the exemplary embodiment of the present invention which internally calculate the first distance 30, and subsequently transmits the first distance to a second controller, as discussed below. In addition to the measured speed, the speed sensor 22 outputs an uncertainty signal 39 to the controller 34, which is subsequently transmitted to a second controller (see below) for determining the quality 12 of the distance estimation 14. The uncertainty signal 39 is indicative of a level of uncertainty in the measured speed of the train 16, and in addition to being a tunable constant, the uncertainty signal 39 may come directly from the speed sensor 22 to the second controller 28, for example.

The system 10 further includes a position determination device, such as a transceiver 24, for example, to provide a measured position of the train 16. In an exemplary embodiment, the transceiver 24 is a global positioning satellite (GPS) device configured to communicate with a plurality of global positioning satellites 44,46, for example. Although FIG. 1 illustrates a pair of global positioning satellites 44,46, the transceiver 24 may be configured to communicate with more than two global positioning satellites, for example. Additionally, in contrast with the first distance 30 of the train 16 from the reference point 13 to the location 18 along the route 20, the measured position is a raw position of the train 16, based on latitude/longitude, for example, and thus does not correlate with a distance from the reference point 13 along the route 20. Although FIG. 1 illustrates one transceiver 24 (i.e., one position determination device), more than one position determination device, such as two or more GPS sensors, wayside equipment, a locomotive operator manual input (upon recognizing a milepost, for example), and any combination thereof. Additionally, although the train 16 illustrated in FIG. 1 includes one locomotive, more than one locomotive may be included on a train, and each locomotive may utilize one or more of the above-mentioned position determination device(s) to determine a distance estimation and a quality of a respective distance estimation to each locomotive. By utilizing more than one position determination device, a more accurate distance estimation and quality of the distance estimation may be achieved. For example, if ten position determination devices were utilized and provide distances in the range of 21.3-21.4 miles, a relatively good quality would accompany a distance estimation in that range. However, if merely two position determination devices were utilized and provide distances of 25 and 30 miles, a relatively bad quality would accompany a distance estimation based on these distances. In an exemplary embodiment, in determining the distance estimation 14, a second controller (see below) may compute an average or a standard deviation of a plurality of distances provided from a plurality of position determination devices. For example, if ten position determination devices provide ten distances with an average of 21.3 miles, this may be used as the distance estimation. However, the second controller may evaluate the standard deviation of these ten distances, which for example may range between 18-27 miles, and thus, may base the quality of the distance estimation on the standard deviation.

The controller 34 is coupled to the transceiver 24. The controller 34 converts the measured position of the train 16 into a second distance 32 of the train 16 along the route 20 based on a memory 36 of the controller 34 which stores the second distance 32 of the train 16 along the route 20, based on the measured position. Thus, the memory 36 effectively stores a list of the measured positions (in terms of latitude/longitude) for the entire route 20, and the distance of each measured position from the particular reference point 13 along the route 20. Although the transceiver 24 illustrated in FIG. 1 transmits a measured position to the controller 34 which is subsequently converted to the second distance 32 from the reference point 13 along the route 20, the transceiver may include an internal memory similar to the memory 36 of the controller 34 which performs this conversion. In addition to the measured position, the transceiver 24 outputs an uncertainty signal 38 to a second controller (see below) for determining the quality 12 of the distance estimation 14. The uncertainty signal 38 is indicative of a level of uncertainty in the measured position of the train 16, and may be reflective of the number of global positioning satellites 44,46 in sufficient communication with the transceiver, for example. The uncertainty signal 38 may be a dilution of precision (DOP) value, which is a unitless value between 1 and 5, as appreciated by one of skill in the art, where a higher number if indicative of greater uncertainty in the measured position of the train 16.

The system 10 further includes a second controller 28, which is configured to determine the distance estimation 14 of the train 16 at the location 18 along the route 20, and the quality 12 of the distance estimation 14 of the train 16 at the location 18 along the route 20. As illustrated in FIG. 1, the second controller 28 determines the distance estimation 14 and the quality 12 of the distance estimation based upon the four inputs of the first distance 30 of the train 16 along the route 20 based on the train speed, the second distance 32 of the train 16 along the route 20 based on the measured position of the train 16, the uncertainty signal 39 provided from the speed sensor 22, and the uncertainty signal 38 provided from the transceiver 24. Although FIG. 1 illustrates that the second controller 28 bases its determination of the distance estimation 14 and the quality 12 of the distance estimation 14 based on the four inputs of the first distance 30, the second distance 32, the uncertainty signal 39 and the uncertainty signal 38, the second controller 28 may base its determination of the distance estimation 14 and the quality 12 based on less than or more than these four inputs. In one exemplary embodiment, the second controller is a kalman filter, for example.

As further illustrated in the exemplary embodiment of FIG. 1, the second controller 28 includes a memory 42. The memory 42 stores prior distance estimations and respective prior quality values for previous locations from the location 18 along the route 20. As illustrated in the exemplary embodiments of FIGS. 3-4, which are time plots of the quality 11 (FIG. 3) 12 (FIG. 4) of the distance estimation 14 over time, during a first time period 40 (approximately t=2000-2500 in FIGS. 3-4), the transceiver 24 provides a measured position of the train 16. During this first time period 40, the second controller 28 determines the quality 11,12 of distance estimation 14 based on the first distance 30, the second distance 32, the uncertainty signal 38, and the prior quality values provided from the second controller memory 42. Although the exemplary embodiment of the present invention involves the second controller 28 determining the quality 11,12 based on the first distance 30, the second distance 32, the uncertainty signal 38, and the prior quality values, the second controller 28 may determine the quality 11,12 based on less or more than these values. The quality 12 of the exemplary embodiment of FIG. 4 (in feet) is the absolute value of the quality 11 of the exemplary embodiment of FIG. 3, with the exception of a second time period 48 when the transceiver 24 fails to provide a measured position of the train 16 (discussed below). As an example, if at a time t₁=2600 during the first time period 40, the first distance 30 is 100 feet, the second distance 32 is 95 feet, the uncertainty signal 38 is 4 (high), and a prior quality value before t₁ was 3 feet, the second controller 28 may determine that the quality 12 is 4 feet. Since the uncertainty signal 38 was high, the second controller 28 will likely increase the quality 12 from its prior value of 3 feet, to the value of 4 feet. Thus, the second controller 28 essentially continuously propagates the quality 12, based on the uncertainty signal 38, the first distance 30, the second distance 32 and the prior quality value(s). Also, the second controller 28 computes the distance estimation 14 by adding the quality 12 to the second distance 32 (if the second distance 32 is less than the first distance 30), or by subtracting the quality 12 from the second distance 32 (if the second distance 32 is greater than the first distance 30). In this example, the second distance 32 is less than the first distance 30, so the second controller 28 adds the quality 12 to the second distance 32 to arrive at the distance estimation 14: 95 feet+4 feet=99 feet. To continue this example, at a second time t₂=2800 during the first time period 40, the first distance 30 is 250 feet, the second distance 32 is 240 feet, the uncertainty signal 38 is 2 (low), and the previous quality 12 was 3 feet, as previously computed. Since the uncertainty signal 38 is low, the second controller 28 will likely decrease the quality 12 from its prior value of 4 feet, to the value of 3 feet, for example. Additionally, the second controller 28 will compute the distance estimation 15 (FIG. 1) of the train 16 at the later time t₂ to be the sum of the second distance 32 and the new quality 12: 240 feet+3 feet=243 feet. FIG. 1 illustrates the distance estimations 14,15 of the train 16 at the respective time instants t₁,t₂. The numeric distances in the above example are merely exemplary, and thus the second controller 28 may determine the same or different values as those above.

As will be appreciated by one of skill in the art, the speed sensor 22 continuously measures the speed of the locomotive 17, continuously provides the speed information to the controller 34 and thus the second controller 28 receives first distance 30 data on a continuous time interval basis. However, the transceiver 24 does not routinely provide continuous measured positions of the train 16, but instead provides these measured positions at diluted time intervals, based on the availability of the satellite signals, in addition to other factors, for example. Thus, the second controller 28 receives the second distance 32 data from the controller 34 on a diluted time interval basis. Based on the difference in the continuous and diluted time intervals of the respective first and second distance 30,32 data provided to the second controller 28, the second controller 28 dynamically determines the quality 12 of the distance estimations on a diluted time interval basis, which effectively acts as a correction to the first distance 30 provided on the continuous time interval basis.

As further illustrated in the exemplary embodiment of FIGS. 3-4, during a second time period 48 (approximately t=3000-3500), the transceiver 24 ceases to provide the measured position of the train 16. To determine if the transceiver 24 has ceased to provide a measured position of the train 16, the controller 34 compares the first distance 30 and the second distance 32 to determine a precision of the second distance 32 relative to the first distance 30, and further to determine if the precision falls below a threshold level for a threshold period of time. If the controller 34 determines that the transceiver 24 has ceased to provide any measured position, or that the measured position is not adequately precise, the controller sends a signal to the second controller 28 to modify its method of computing the quality 12 of the distance estimation 14, as discussed below. During the second time period 48, the quality 11 in FIG. 3 is essentially flat, as in this particular embodiment, the second controller 28 essentially equates the current quality with the prior quality value. However, for the quality 12 of the distance estimation 14 in the embodiment of FIG. 4, the second controller 28 determines an increase in the quality 12 based on a quality value prior to the transceiver 24 having ceased to provide a measured position of the train 16, and a pair of configurable constants Kl,K2, based on an uncertainty in the speed of the train 16, as follows:

Quality Increase (t)=K2*Previous Quality*t+K1*t

Accordingly, during the initial portion of the second time period 48 in FIG. 4, the quality 12 essentially is an increasing line having a slope based on the product of the previous quality prior to the transceiver 24 having ceased to provide a measured position and a configurable constant K2, based on the speed uncertainty. During the second time period 48, when the transceiver 24 has started to communicate back with the controller 34, the second controller 28 determines a decrease in the quality 12 based on the previous quality prior the transceiver 24 starting to communicate back to provide a measured position of the train 16 and a skew based on the uncertainty signal 38, as follows:

Quality Decrease (t)=Previous Quality+skew (based on uncertainty signal)

Accordingly, the lower the uncertainty signal 38 value that is provided from the transceiver 24, the greater the decrease in the quality back down to the range of quality values prior to the transceiver 24 having ceased to provide the measured position. As will be appreciated by those of skill in the art, the quality 12 increases once the transceiver 24 ceases to provide a measured position since only one distance measurement (speed) is being utilized, and the GPS distance measurement will not be relied upon significantly until the uncertainty signal 38 is once again relatively low.

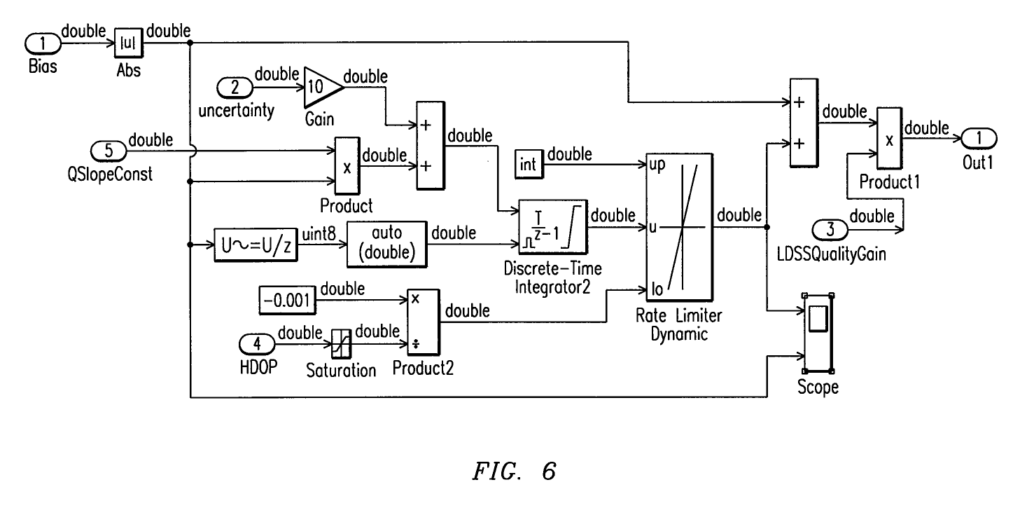

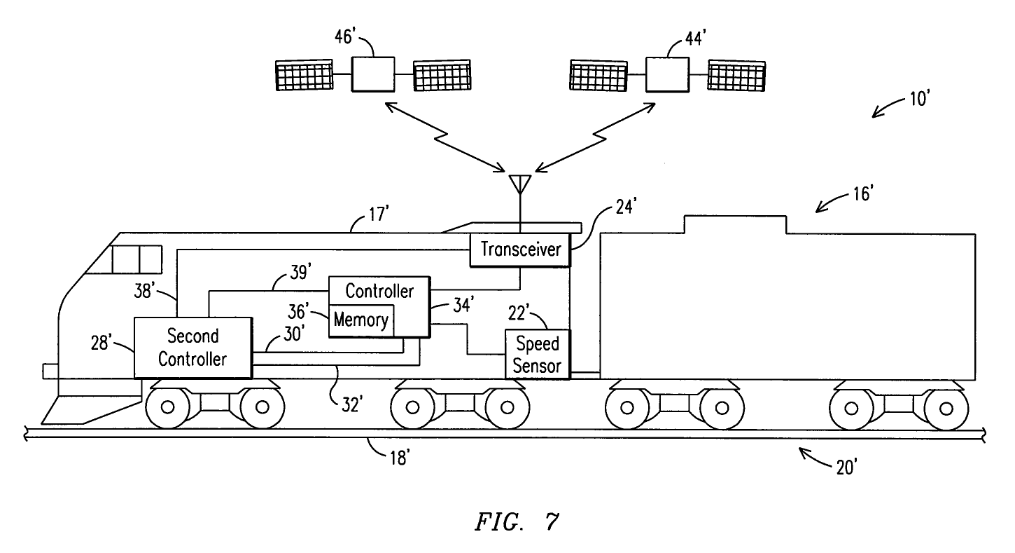

The controller 34 is switchable to an automatic mode. In the automatic mode, the controller 34 determines an initial parameter of the train 16 for each location along the route 20 prior to the train 16 commencing a trip along the route 20. In the automatic mode, the controller 34 utilizes the distance estimation 14 and the quality 12 of the distance estimation to adjust the initial parameter at an upcoming location 19 (FIG. 1) to a modified parameter for the upcoming location 19 (FIG. 1) along the route 20. For example, the controller 34 in the automatic mode may use the distance estimation 14 and quality 12 at the initial location 18, in a worse case scenario, when determining whether to modify an initial parameter planned for the upcoming location 19. For example, if the quality 12 of the distance estimation 14 was 10 feet, then the controller 34 may plan to reset the initial parameter at the upcoming location 19 to a location 10 feet short of the upcoming location 19, depending on the importance of setting the initial parameter at the upcoming location 19. Additionally, the controller 34 may utilize the distance estimation 15 of the upcoming location 19 to confirm when the train 16 is actually at the upcoming location 19 to track the accuracy of the initial parameter at the upcoming location 19. More specifically, in an exemplary embodiment, if the initial parameter is the speed of the train 16, the distance estimation 14 and the quality 12 of the distance estimation may be utilized to adjust the initial speed parameter of the train to a modified speed parameter at a distance prior to the upcoming location 19 of the train (where the quality 12 may be used to determine the distance prior to the upcoming location 19), to comply with a speed restriction at the upcoming location 19 along the route 20. The controller 34 is switchable from the automatic mode to a manual mode, in which a train operator determines the initial parameter of the train at each location along the route. The controller 34 is configured to switch from the automatic mode to the manual mode upon the quality 12 being outside a predetermined acceptable range stored in the memory 36 of the controller 34. FIG. 6 illustrates an exemplary embodiment of a block diagram of the internal operations of the second controller 28, for example. FIG. 6 is merely an example of one block diagram arrangement of the second controller 28, and thus various other block diagram arrangements are possible.

FIG. 7 illustrates an additional embodiment of a system 10′ for determining a quality 12′ of a distance estimation of a train 16′ at a location 18′ along a route 20′. The system 10′ includes a speed sensor 22′ to determine a speed of the train 16′ at the location 18′ along the route 20′. The system 10′ further includes a transceiver 24′ to measure a position of the train 16′. The system 10′ further includes a second controller 28′ to determine the quality 12′ of the distance estimation during a first time period 40′ when the transceiver 24′ measures the position of the train 16′. As illustrated in the plot of FIG. 5 and FIG. 7, the quality 12′ is based on the uncertainty signal 38′ and an uncertainty signal 39′ in the speed of the train 16′. Although the exemplary embodiment describes that the quality 12′ is based on the sum of the uncertainties in the measured position and the speed, the quality 12′ may be based on only one of these uncertainties. As shown in the plot of FIG. 5 during the second time period 48, since the quality 12′ is based on the sum of the uncertainties in the speed and the measured position, the quality 12′ continuously increases to a large number (approx 4000 feet), however other versions of the system 10′ may be adjusted such that the quality 12′ does not continuously increase to such large amounts. The second controller 28′ is configured to determine the distance estimation based upon the first distance 30′, the second distance 32′, and the quality 12′ of the distance estimation.

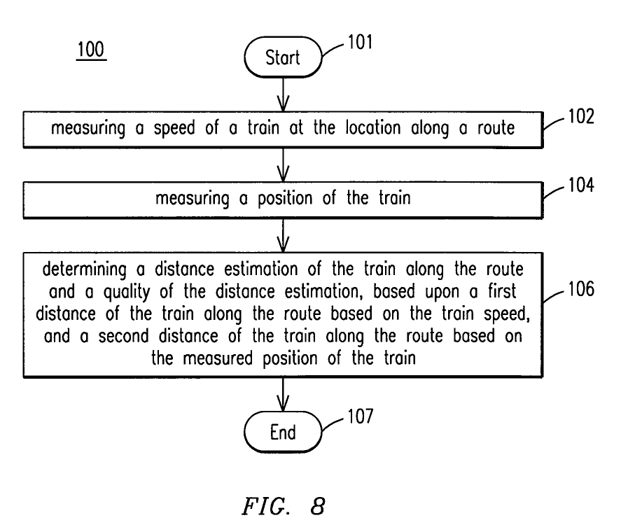

FIG. 8 illustrates a flow chart of an exemplary embodiment of a method 100 for determining a quality 12 of a distance estimation 14 of a train 16 at a location 18 along a route 20. The method 100 begins at 101 by measuring 102 a speed of the train 16 at the location 18 along the route 20. The method 100 further includes measuring 104 a position of the train 16. The method 100 further includes determining 106 the distance estimation 14 of the train 16 along the route 20 and the quality 12 of the distance estimation, based upon a first distance 30 of the train 16 along the route 20 based on the train speed, and a second distance 32 of the train 16 along the route 20 based on the measured position of the train 16, before ending at 107.

This written description uses examples to disclose embodiments of the invention, including the best mode, and also to enable any person skilled in the art to make and use the embodiments of the invention. The patentable scope of the embodiments of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

That which is claimed is:

1. A system for determining a quality of a location estimation of a powered system at a location, said system comprising:
a first sensor configured to measure a first parameter of said powered system at said location;
a second sensor configured to measure a second parameter of said powered system at said location; and
a second controller configured to determine said location estimation of said powered system and said quality of the location estimation, based upon a first location of said powered system based on said first parameter, and a second location of said powered system based on said second parameter of said powered system.

2. The system of claim 1, wherein:
said powered system is a rail vehicle, said location estimation is a distance estimation of said rail vehicle at a location along a route;
said first sensor is configured to measure the first parameter of said rail vehicle at said location along said route;
said second sensor is configured to measure the second parameter of said rail vehicle at said location along said route; and
said second controller is configured to determine said distance estimation of said rail vehicle along the route and said quality of the distance estimation, based upon a first distance of said rail vehicle along the route based on said first parameter, and a second distance of said rail vehicle along the route based on said second parameter of said rail vehicle.

3. The system of claim 2, wherein:
said first sensor is a speed sensor configured to measure a speed of said rail vehicle at said location along the route;
said second sensor is a position determination device configured to provide a measured position of said rail vehicle; and
said second controller is configured to determine said distance estimation and said quality of the distance estimation, based upon said first distance based on said rail vehicle speed, and said second distance based on said measured position of said rail vehicle.

4. The system of claim 3, wherein said rail vehicle is a train having a plurality of locomotives, each locomotive including at least one speed sensor, at least one position determination device, and said second controller to determine said distance estimation and said quality of the distance estimation based upon said first distance and said second distance.

5. The system of claim 3, further comprising:
a controller coupled to said speed sensor and said second controller, said controller being configured to determine said first distance of said rail vehicle along the route based on said speed of the rail vehicle prior to said location along the route.

6. The system of claim 5, wherein said controller is coupled to said position determination device, said controller is configured to convert said measured position of said rail vehicle into said second distance of said rail vehicle along the route based on a memory of said controller for storing said second distance of said rail vehicle along the route based on said measured position.

7. The system of claim 6, wherein:
said position determination device is configured to transmit an uncertainty signal to said second controller, said uncertainty signal being indicative of a level of uncertainty in said measured position of said rail vehicle;
said speed sensor is configured to transmit an uncertainty signal to said controller, said uncertainty signal being subsequently re-transmitted to said second controller, said uncertainty signal being indicative of a level of uncertainty in the measured speed of the train.

8. The system of claim 7, wherein during a first time period when said position determination device provides said measured position of said rail vehicle, said second controller is configured to determine said quality of distance estimation based on at least one of said first distance, said second distance and said uncertainty signal.

9. The system of claim 8, wherein said second controller includes a memory, said memory being configured to store a plurality of prior distance estimations and a respective plurality of prior quality values for a plurality of previous locations from said location along the route, during said first time period said second controller is configured to determine said quality of distance estimation based on said first distance, said second distance, said uncertainty signal and said plurality of prior quality values.

10. The system of claim 9, wherein said position determination device is at least one global positioning satellite (GPS) device configured to communicate with a plurality of global positioning satellites.

11. The system of claim 10, wherein said distance estimation of said rail vehicle at said location along the route is based on one of a sum and difference of said quality of said distance estimation and said second distance.

12. The system of claim 11, wherein said second controller is configured to receive said first distance from said controller on a continuous time interval basis, said second controller is configured to receive said second distance from said controller on a diluted time interval basis, said second controller is configured to dynamically determine a correction to said first distance based on said second distance provided at said diluted time interval, said correction being based on said quality of said distance estimation.

13. The system of claim 9, wherein during a second time period when said position determination device ceases to measure said position of the rail vehicle, said second controller is configured to determine said quality of distance estimation based on a prior quality value before said position determination device ceased to provide said measured position, and a constant based on an uncertainty in said speed of the rail vehicle.

14. The system of claim 13, wherein during said second time period when said position determination device ceases to measure said position of the rail vehicle, said quality increases; during said second time period when said position determination device begins to remeasure said position of the rail vehicle, said second controller is configured to determine a decrease in the quality of the distance estimation.

15. The system of claim 9, wherein said controller is configured to compare said first position and said second position to determine a precision of said second position relative to said first position, during a second time period when said controller determines that the precision falls below a threshold level for a threshold period of time, said second controller is configured to determine said quality of distance estimation based on a prior quality value prior to said threshold period of time, and a constant based on an uncertainty in said speed of the rail vehicle.

16. The system of claim 9, wherein said controller is switchable to an automatic mode, said controller in said automatic mode is configured to determine an initial parameter of said rail vehicle for each location along the route prior to the rail vehicle commencing a trip along the route.

17. The system of claim 16, wherein said controller in said automatic mode is configured to utilize said distance estimation and said quality of the distance estimation to adjust said initial parameter of the rail vehicle to a modified parameter for an upcoming location along the route.

18. The system of claim 17, wherein said parameter is the speed of the rail vehicle; said distance estimation and said quality of the distance estimation are utilized to adjust said initial speed parameter of the rail vehicle to said modified speed parameter at said upcoming location of the rail vehicle, to comply with a speed restriction at said upcoming location along the route.

19. The system of claim 16, wherein said controller is switchable from said automatic mode to a manual mode in which a rail vehicle operator determines the initial parameter of the rail vehicle at each location along the route, said controller is configured to switch from said automatic mode to said manual mode upon said quality being outside a predetermined acceptable range stored in the memory of the controller

20. A system for determining a quality of a location estimation of a powered system at a location, said system comprising:
a speed sensor configured to determine a speed of said powered system at said location;
a position determination device configured to provide a measured position of said powered system; and
a second controller configured to determine said quality of the location estimation during a first time period when said position determination device provides said measured position of the powered system, said quality based on at least one of an uncertainty in said position of said powered system and an uncertainty in the speed of said powered system.

21. The system of claim 20, wherein said powered system is a rail vehicle at a location along a route; said location estimation is a distance estimation of the rail vehicle along the route, and wherein:
said speed sensor is configured to determine a speed of said rail vehicle at said location along said route;
said position determination device is configured to provide a measured position of said rail vehicle; and
said second controller is configured to determine said quality of the distance estimation during a first time period when said position determination device provides said measured position of the rail vehicle, said quality based on at least one of an uncertainty in said position of said rail vehicle and an uncertainty in the speed of said rail vehicle.

22. The system of claim 21, wherein said position determination device is configured to transmit a position uncertainty signal to said second controller, said speed sensor is configured to transmit a speed uncertainty signal to said second controller, said position uncertainty signal and said speed uncertainty signal being indicative of said respective uncertainty in said position and said uncertainty in the speed of the rail vehicle.

23. The system of claim 22, wherein said second controller is configured to determine said distance estimation based upon a first distance of said rail vehicle along the route based on said rail vehicle speed, a second distance of said rail vehicle along the route based on said position of said rail vehicle, and said quality of the distance estimation.

24. The system of claim 23, wherein during a second time period when said position determination device ceases to provide said measured position of the rail vehicle, said quality is based on said uncertainty in the speed of the rail vehicle.

25. A method for determining a quality of a location estimation of a powered system at a location, said method comprising:
measuring a speed of the powered system at the location;
measuring a position of the powered system; and
determining the location estimation of the powered system and the quality of the location estimation, based upon a first location of the powered system based on the speed, and a second location of the powered system based on the measured position of the powered system.
